(19) United States
(12) Patent Application Publication
(10) Pub. No.: US 2013/0017732 A1
(43) Pub. Date: Jan. 17, 2013

(54) METHOD AND APPARATUS FOR DETECTING IMPROPER CONNECTOR SEATING OR ENGAGEMENT

(71) Applicant: Eugene James PARKE, Noblesville, IN (US)

(72) Inventor: Eugene James PARKE, Noblesville, IN (US)

(21) Appl. No.: 13/349,375

(22) Filed: Jan. 12, 2012

Related U.S. Application Data
(60) Provisional application No. 61/461,183, filed on Jan. 15, 2011.

(51) Int. Cl. H01R 24/00

(52) U.S. Cl. 439/660

(57) ABSTRACT

Methods and apparatus for determining whether a connector is properly seated are disclosed. One such apparatus is directed to a connector including a plurality of transmission lines and a plurality of contact elements. The transmission lines include functionally coupling lines that are configured to transmit data signals. In addition, the contact elements are disposed at an end of the connector and include at least one coupling contact element that is configured to couple at least one of the functionally coupling lines to a device element. The contact elements further include at least one connection sensing contact element that is disposed toward at least one side edge of the connector and is shorter than the coupling contact element. Methods include monitoring a detection signal in a global connection loop. Other methods include comparing a detection signal to a threshold to determine whether a connector is properly seated.

### RELATED APPLICATION INFORMATION

This application claims priority to provisional application Ser. No. 61/461,183 filed on Jan. 15, 2011, incorporated herein by reference.

### TECHNICAL FIELD

The present invention generally relates to interconnectors, and, more particularly, to systems, apparatuses and methods for detecting improper attachment or engagement of interconnectors.

### BACKGROUND

Coupling multiple printed circuit board (PCB) assemblies is problematic in that it is difficult to attain both reliable connections and ease of factory assembly. The need to interconnect multiple PCB assemblies in a high-speed factory environment while maintaining ease of serviceability of such assemblies has led to the usage of connection methods that do not utilize through-hole soldering techniques to link one PCB or other electronic component to another PCB or the like. Thus, flat flexible cable (FFC) connectors and other electronic connectors, such as Molex connectors, are used extensively as a solution.

### SUMMARY

One presently preferred embodiment is directed to a connector including a plurality of transmission lines and a plurality of contact elements. The transmission lines include functionally coupling lines that are configured to transmit data signals. In addition, the contact elements are disposed at an end of the connector and include at least one coupling contact element that is configured to couple at least one of the functional coupling lines to a device element. The contact elements further include at least one connection sensing contact element that is disposed toward at least one side edge of the connector and is shorter than the coupling contact element.

An alternative embodiment is directed to a method for determining whether a connector is properly seated in or engaged with at least one of a plurality of device elements. The method includes measuring at least one aspect of a signal transmitted through contact elements that are disposed toward opposing side edges of the connector and that are coupled to one of the device elements. In addition, the measurement is compared to a threshold value. In response to the comparison, an indication that the connector is improperly or properly seated in at least one of the device elements is provided as an output.

Another embodiment is also directed to a method for determining whether a connector is properly seated or engaged. In accordance with the method, a signal that is transmitted through a plurality contact elements is received. The contact elements include at least one contact element that is disposed toward a side edge of the connector, where a first subset of the contact elements is disposed at a first end of the connector and is coupled to a first device element. Further, a second subset of the contact elements is disposed at a second end of the connector and is coupled to a second device element. The signal is monitored to determine whether the signal has been lost. In response to determining that the signal has been lost, an indication that the connector is improperly seated in at least one of the device elements is provided as an output.

### BRIEF DESCRIPTION OF THE DRAWINGS

The teachings of the present invention can be readily understood by considering the following detailed description in conjunction with the accompanying drawings, in which:

FIG. 1 is an illustration of an improper seating of a Molex connector that can be detected in accordance with embodiments of the present principles.

FIG. 2 is an illustration of an improper seating of an FFC connector that can be detected in accordance with embodiments of the present principles.

FIG. 3 is a block diagram of an embodiment of a connector including sensing pins in accordance with exemplary aspects of the present principles.

FIG. 4 is a block diagram of an embodiment of a connector that is properly seated.

FIGS. 5 and 6 are block diagrams of an embodiment of a connector that is improperly seated.

FIG. 7 is an illustration of sensor pin depth in an embodiment of a connector.

FIG. 8 is an illustration of a local loop back implementation in an embodiment of a connector.

FIG. 9 is an illustration of a local loop back implementation in a stiffener backing of a connector embodiment.

FIG. 10 is an exploded view of an embodiment of a connector including a local loop back implemented in a stiffener backing of the connector.

FIG. 11 is a high-level block/flow diagram of a monitoring system employing a global detection loop in accordance with an exemplary embodiment.

FIG. 12 is a high-level block/flow diagram of a monitoring system employing a local detection loop in accordance with an exemplary embodiment.

FIG. 13 is a high-level flow diagram of a method for determining whether a connector is properly seated in accordance with an exemplary embodiment.

FIG. 14 is a high-level flow diagram of an alternative method for determining whether a connector is properly seated in accordance with an exemplary embodiment.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF PREFERRED EMBODIMENTS

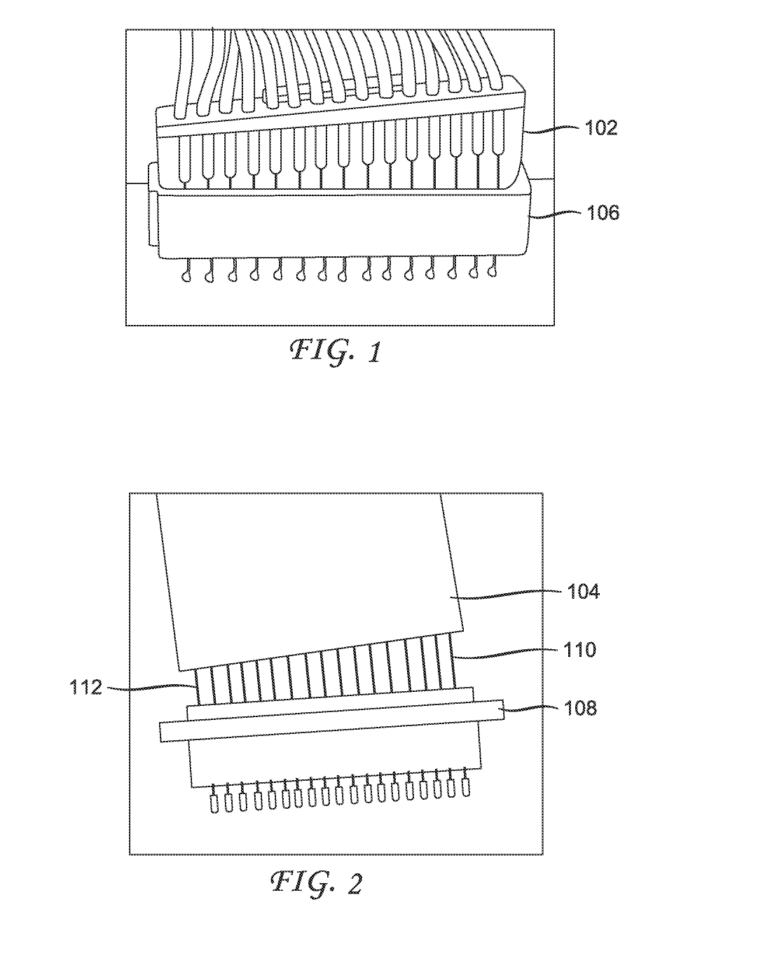

As indicated above, wire interconnects are used extensively to couple electronic or optical components. However, one disadvantage of current methods employing these interconnects is that couplings are generally implemented manually. Manually-inserted cables are at risk of being improperly seated but yet inserted to a degree that is sufficient to provide a temporarily functional connection. In this situation, an assembly can pass factory tests but is at risk of failing in the field. Referring in specific detail to the drawings in which like reference numerals identify similar or identical elements throughout the several views, and initially to FIGS. 1 and 2, examples of improperly seated connectors are illustratively depicted. FIG. 1 depicts an example of a Molex connector 102 while FIG. 2 illustrates an example of an FFC connector 104. As shown in FIGS. 1 and 2, the connectors 102 and 104 are respectively connected to headers 106 and 108 in a way that enables proper functioning of the coupling between PCBs. However, the improper seating angle of the connectors can cause the coupling to detach when exposed to normal vibration and thermal cycling over time. In these two particular examples, the couplings resulted in functional factory instruments, but the connections eventually failed in the field. To overcome the risk of improper seating, human-managed visual checks and instrument functionality tests are used to capture incorrectly assembled connectors. However, both of these processes do not accurately detect connections that are improperly seated in a way that permits temporary functionality but is prone to failure over time when exposed to normal operating conditions.

Exemplary embodiments described herein include apparatuses, systems and methods that enable accurate and quick validation of wire couplings to ensure that cables are inserted into a header at the proper depth for positive contact. This depth check can be made via electrical measurements using either external factory equipment or internal system software. Depth sensing gauges located on the outer edges, at the first and last position, of a flat flexible cable/header combination or electronic interconnector/header combination can be employed. The gauge mechanism can be used to monitor proper insertion depth of the cable or connector into the header, proper insertion angle and positive contact between the functionally coupling pins of the cable and the header pins after the assembly process. Such monitoring according to the invention can provide the added advantage of not increasing or not substantially increasing the volume or area of the electronic interconnector/header or other elements of the apparatus and yet provide connection monitoring.

Exemplary aspects of the present principles provide various advantages and improvements in the relevant art. For example, in accordance with one exemplary aspect, sensing contact elements (e.g., pins) situated at the edge positions of a cable can be configured to be shorter than the functionally coupling contact elements located between the sensing contact elements. “Functionally coupling contact elements” or “functionally coupling lines” as employed herein should be understood to mean contact elements or lines, respectively, in a corresponding cable that enable connectivity and communication of data between device elements. For example, coupling contact elements can be used in the cable to transfer data between PCBs that are connected through the cable. Here, the shorter length of the sensing contact elements, which can be implemented as pins, specifically enable the detection of improper insertion of cables that permit temporary functionality. For example, improper insertion angles of a cable can lead to the situation illustrated in FIGS. 1 and 2, where the cables are temporarily functional but are susceptible to failure when exposed to normal operating conditions over time. However, if the edge contact elements, for example, pins 110 and 112, were reconfigured to be shorter than the other contact elements or pins therebetween, then connection measurements would not indicate functionality and a problem with the connection can be detected. For example, as shown in FIG. 2, if the pin 110 were shorter, then there would be no electrical contact with the corresponding socket in the header, thereby ensuring that an improperly seated cable would not pass functionality testing. In this way, the shorter configuration of the sensing pins can ensure that only cables that have properly seated functional coupling pins that are inserted at a proper depth would pass connection testing. This aspect is especially beneficial when the sensing pins are used for sensing purposes only. In certain embodiments, such sensing pins can be implemented on the back of the cable, as opposed to its edges, so that the edge pins can also be used as functional coupling pins to maximize the coupling capability of the cable.

According to another exemplary feature, existing cables and headers can be used to ensure proper insertion and contact of the cables. This mechanism offers the capability of ongoing monitoring of the cable connectivity status once the product has left the factory environment. Here, the amplitude of the current running through the edge pins can be monitored to determine whether the pin is at risk of losing contact with the header socket. This capability can warn users if critical data carrying connections are at risk of disconnect by way of ongoing processor monitoring of the depth sensing pin connectivity. In one implementation, a global loop that runs through the edge pins at each component connected by the cable can be monitored periodically to detect whether a proper connection has been broken. In embodiments in which edge pins are implemented with the same length as the other pins, the cable can still be susceptible to the improper couplings described above. However, here, any failure in the field can be immediately detected and corrected without any loss of functionality. For example, due to the fact that the edge pins are the first pins to fail in the scenarios described above with regard to FIGS. 1 and 2, the remaining pins will nonetheless remain functional when an improper connection alert is provided to a user. The system can then inform the user of the particular cable failure, of where the faulty cable is located in the corresponding device and of how the problem can be rectified. In addition, even if the edge pins are implemented as functionally coupling pins, the monitoring feature provides a further advantage in that a user can be immediately notified of their failure. For example, the edge pins can be used for processes that are not active at the time of failure. In this situation, the system can inform a user of the problem prior to the occurrence of any detrimental effects resulting from the failure when the associated processes become active. Although the global loop monitoring feature is described here as being implemented with existing cables, it should be noted that this monitoring feature can also be implemented in embodiments that employ sensing contact elements that have lengths that are different from lengths of functionally coupling contact elements. Moreover, monitoring aspects can also be employed in local loops, as described in more detail herein below.

It should be understood that those skilled in the art will be able to devise various arrangements that, although not explicitly described or shown herein, embody the present principles and are included within its spirit and scope.

All examples and conditional language recited herein are intended for pedagogical purposes to aid the reader in understanding the present principles and the concepts contributed by the inventor to furthering the art, and are to be construed as being without limitation to such specifically recited examples and conditions.

Moreover, all statements herein reciting principles, aspects, and embodiments of the present principles, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that flow and block diagrams presented herein represent conceptual views of illustrative circuitry embodying the present principles. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

The functions of various processing elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware and also computer readable storage mediums for storing software, such as read-only memory (“ROM”), random access memory (“RAM”), and non-volatile storage.

Other hardware, conventional and/or custom, can also be included. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The present principles as defined by such claims reside in the fact that the functionalities provided by the various recited means are combined and brought together in the manner which the claims call for. It is thus regarded that any means that can provide those functionalities are equivalent to those shown herein.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

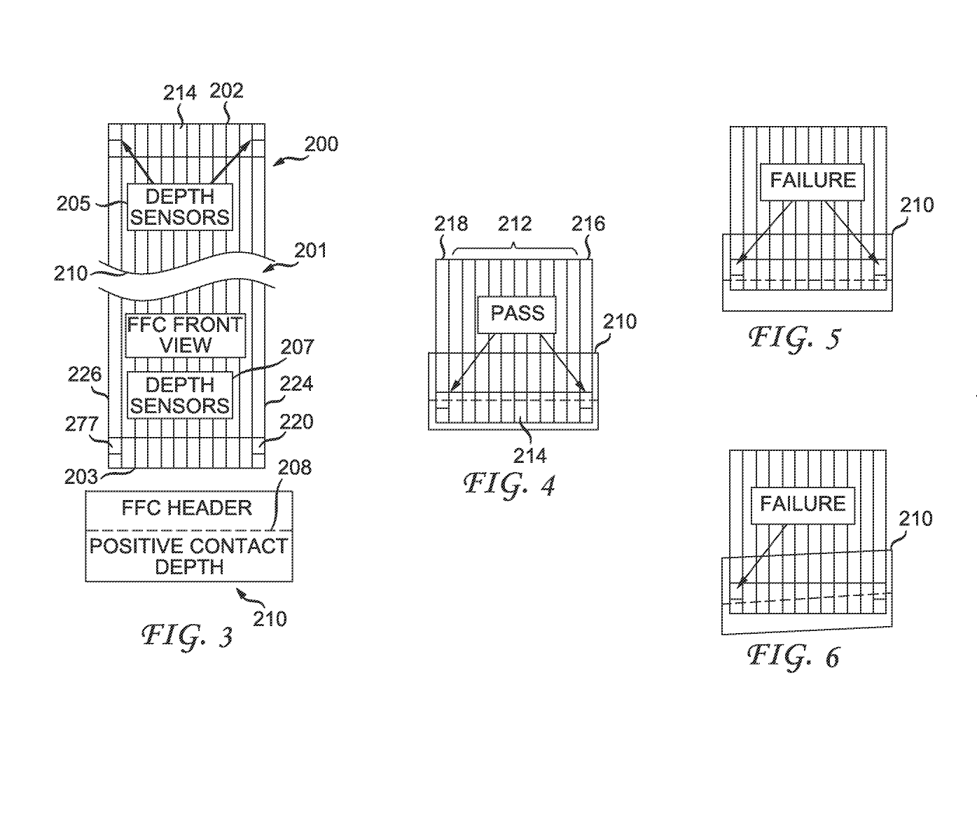

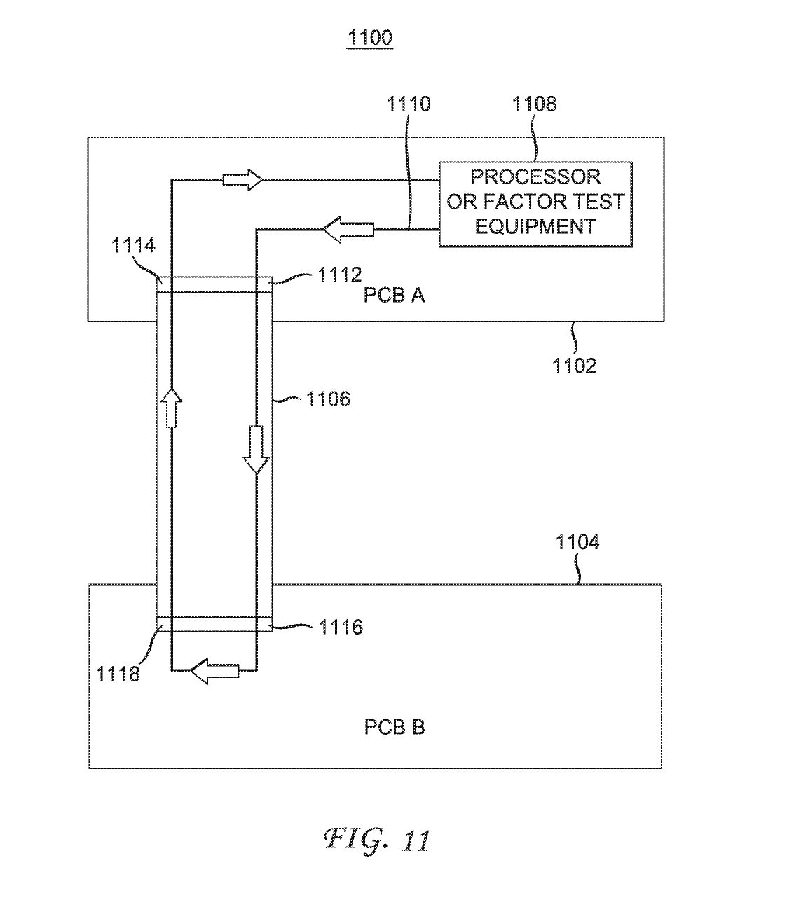

Referring to FIGS. 3-6, an exemplary embodiment 200 of a connector in accordance with the present principles is illustratively depicted. FIG. 3 is a block diagram of a connector 200 and header 210 attached to a device element (not shown here). The connector 200 can be implemented as an FFC connector and can be employed to connect device elements, such as PCBs. Alternatively, it should be noted that the connector 200 can be implemented as optical fibers to connect optical devices. The connector 200 has a first connecting end 202, a second connecting end 203 and an intermediate portion 201. The intermediate portion 201 can include transmission lines 210. The transmission lines 212 can include functionally coupling lines that are configured to transmit signals or data between device elements that are connected by the connector 200. For example, transmission lines 212 that are coupled to standard coupling contact elements 214, implemented here as pins, can be configured as functionally coupling lines. In turn, transmission lines 216 and 218 coupled to connection sensing contact elements 220 and 222, implemented here as pins, respectively, can be employed for depth sensing purposes, using, for example, a global loop sensing configuration, discussed in more detail herein below with respect to FIG. 11. It should also be noted that the transmission lines 216 and 218 can be used for only depth sensing purposes or for both depth sensing purposes and data communication between device elements in certain exemplary embodiments. It should be further noted that the transmission lines 212 can be electrically conducting wires or can be optical transmission mediums, if the device elements connected by the connector are optical devices.

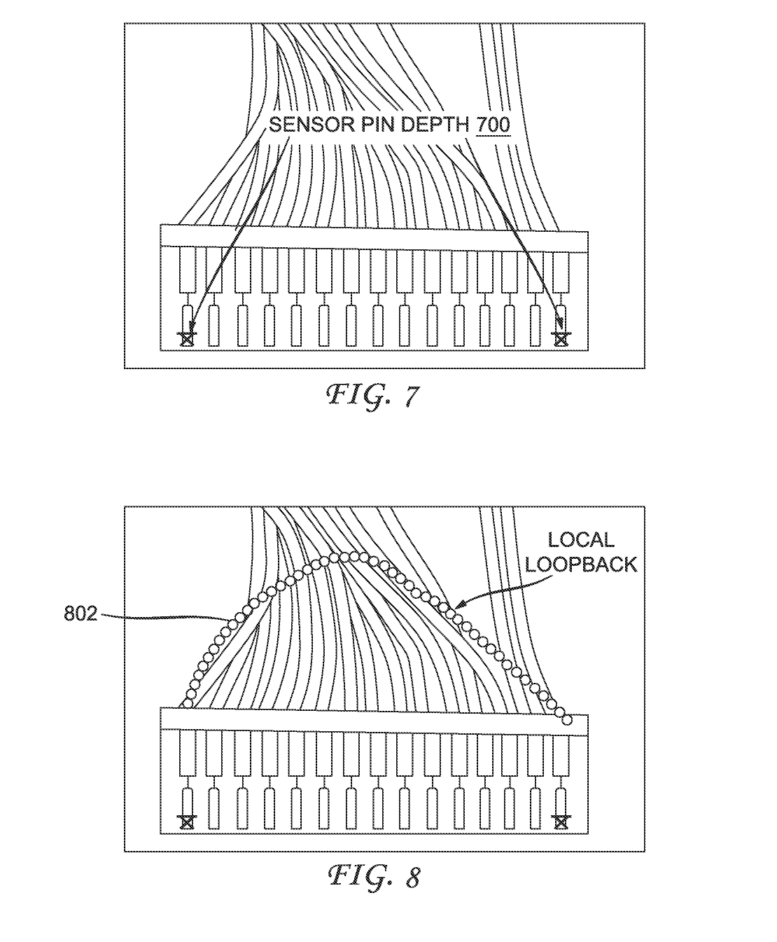

As illustrated in FIG. 3, the contact elements 220 and 222 of depth sensors 205 and 207 are shorter in length than the functionally coupling contact elements 214 between the connection sensing contact elements at ends 202 and 203, respectively. In addition, the contact elements 220 and 222 of the depth sensors 205 and 207 are disposed toward the opposing, side edges 224 and 226 of the connector. Further, insertion of both of the edge depth sensing contact elements 220 and 222, through the boundary 208 in the header 210 ensures that the functionally coupling contact elements 214 are inserted to a positive contact depth. For example, FIG. 4 shows the connector 200 properly engaged in the header 210, as the sensing contact elements 220 and 222 have been inserted through the boundary and are in electrical contact with their corresponding sockets in the header 210. In contrast, FIGS. 5 and 6 illustrate examples of the connector 200 when it is improperly engaged in the header. For example, in FIG. 5, the failure is due to an insufficient insertion depth of the connector, even though the connector is inserted evenly. In FIG. 6, the failure is due to the uneven insertion of the connector. In each of these cases, both of the sensing contact elements on a connecting end of the connector are not inserted through the positive contact boundary 208. FIG. 7 provides a more detailed view of the sensor pin depth 700, illustrating that the sensor pins at the edges of the connecting end are shorter than the functional coupling pins. Accordingly, the sensing pins can differ in depth from the other pins (or active pins). As indicated above, use of sensor edge pins that have a shorter length or depth than the functional coupling pins ensures that improper seating as illustrated in FIGS. 5 and 6 is detected. However, it should be noted that the depth can vary according to design needs. Depth of the sensing pin can be dependent on the width of the connector and can be calibrated and mated with a specific header.

In one embodiment, the outer depth sensing pins would not be used as critical connection paths because they can have limited interconnectivity between the cable and the header pins, which can place these outer connections at risk of improper contact. These outer pins and the space they utilize can be sacrificed to ensure the remaining internal pins have been properly inserted.

It should be noted that in various exemplary embodiments, outer sensing contact elements can compose either a complete, global, closed circuit loop between the married PCBs that passes through to both ends of the cable or loops that are localized at each connector end. In either the global or the localized case, the loop would be activated when the connector end(s) is/are properly seated in the header, as, for example, illustrated in FIG. 4. In other words, the loop is activated in that it has an electrical current, or an optical connection in optical connector embodiments, running through it due to contact of both sensing contact elements with a corresponding socket in the header.

FIG. 8 illustrates an embodiment including two sensor pins at the lateral ends of the connector attached to a line 802 providing a local loopback therebetween such that there can be some appropriate electrical communication transmitted through the local loopback when the connector is properly inserted and positioned into the header.

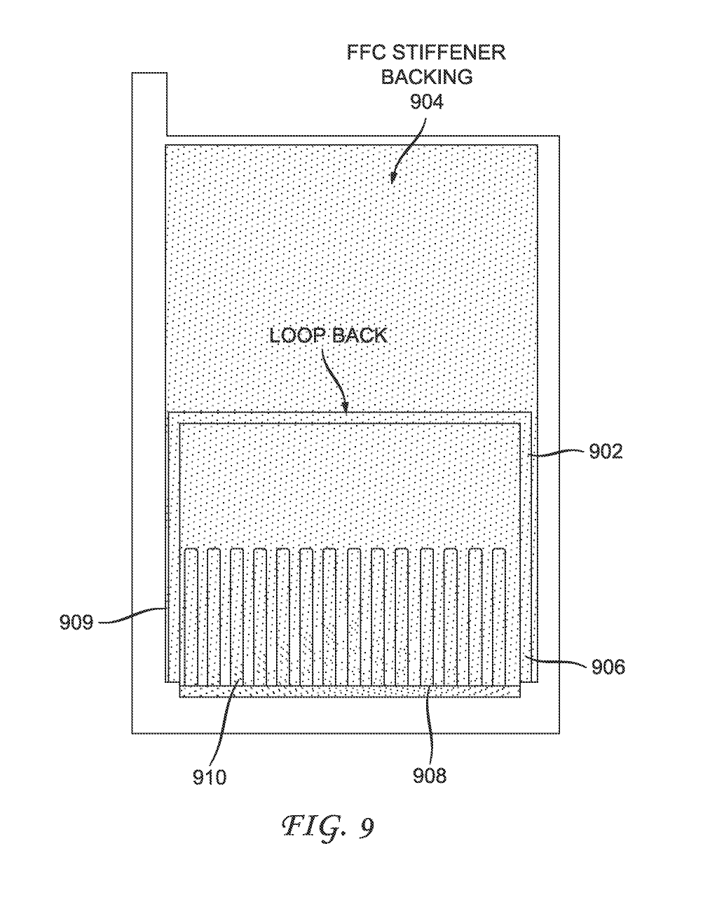

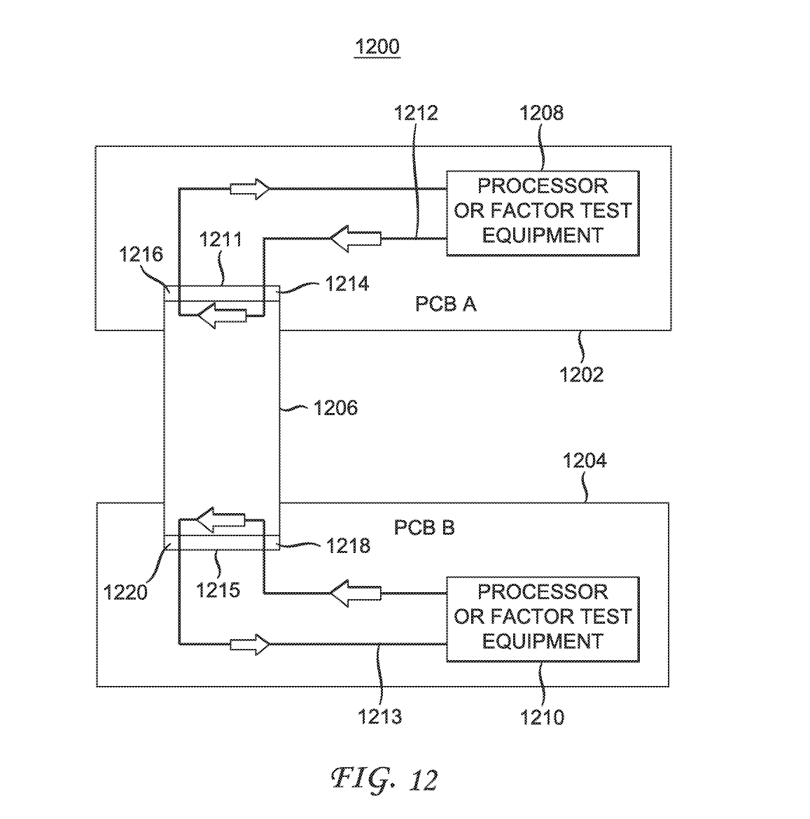

FIG. 9 provides another example of a local loopback embodiment. In this embodiment, an FFC cable can include a trace 902 printed on the stiffener backing 904 to accommodate the localized loop. Similar to FIG. 8, an appropriate electrical communication is implemented when the connector in properly inserted and positioned into the header. Here, the loopback is embedded into the FFC stiffener. The exposed contacts 909 and 906 are on opposite sides of the stiffener 904. As illustrated in FIG. 9, the contacts 909 and 906 of the loop back line 902, although on a different vertical plane than the functional coupling pins 908, are shorter than the functional coupling pins 908 and are situated on the edges of the connector to retain the detection advantages described above with respect to FIGS. 2-7. Further, the contact elements 909 and 906 are directly coupled on the connector through the loop back trace 902 to enable local signal transmission, as described in more detail herein below with respect to FIG. 12. Similar to the embodiment described above with respect to FIGS. 3-6, the coupling pins 908 are connected to functionally coupling lines that are configured to transmit signals or data between device elements that are connected by the connector. Further, the coupling pins 908 are disposed between the connection sensing pins 909 and 906 to retain the detection advantages described above with respect to FIGS. 2-7. It should be noted that if the local loopback is on a different plane than the coupling contact elements, as illustrated in FIG. 9, and is utilized for detection of an improperly seated connector, the outer channels of the FFC need not be sacrificed for sensing purposes. However, here, the connector should be used with a header that is configured such that the header employs contacts on the front side for the normal, standard FFC connections and has a separate sensor built into the portion that is in contact with the back side of the connector to detect an active loopback connection.

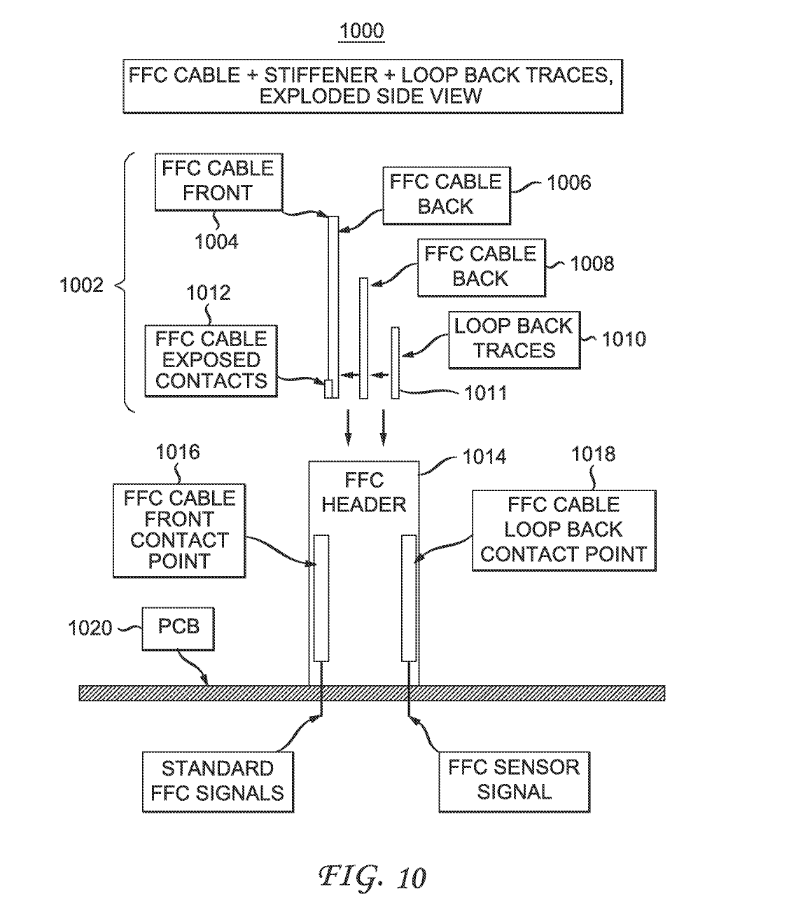

FIG. 10 provides an exploded, side view of a connector and header system 1000 employing a local loop back in a stiffener backing according to an exemplary embodiment. Specifically, FIG. 10 illustrates a receiving header and a general graphical representation of stiffner loopback embodiments, an example of which is depicted in FIG. 9. The system 1000 includes an example of an end of an FFC cable connector 1002, which includes a front or top side 1004 and a back side 1006. Exposed contacts 1012 are disposed on the front side 1004 for insertion into a front contact point 1016 of an FFC header 1014 of a PCB 1020. A stiffener backing 1008 is provided on the back side 1006 of the cable connector 1002. As indicated above with respect to FIG. 9, loop back traces 1010 can be printed on the stiffener backing 1008 for coupling to a loop back contact point 1018 on the bottom portion of the header 1014 when the cable connector 1002 is inserted into the header 1014. The loop back traces 1010 can be formed of any appropriate conductive material and can be formed of the same material of which conventional exposed contacts of an FFC connector are made. As discussed above with respect to FIG. 9, the connection sensing contact elements 1011 of the loopback traces 1010 form a plane that is different from a plane formed by coupling contact elements 1012.

Referring now to FIG. 11, an embodiment of a system 1100 for detecting an improper seating of a connector that utilizes a global detection loop is illustratively depicted. In accordance with this embodiment, the depth sensor status can be determined during assembly through the use of factory-automated test equipment. Alternatively, long-term microprocessor monitoring can be employed by looping though the cable to determine the status of the connection sensing contact elements at the ends of the connector.

The system 1100 can include a first device element 1102 and a second device element 1104 that are interconnected by a connector 1106. The device elements 1102 and 1104 can be PCBs, or can be optical devices in embodiments in which optical fibers are employed as transmission lines in the connector 1106. The connector 1106 can be implemented as the connector 200 described above with respect to FIGS. 3-7. For example, the connector 1106 can include functional coupling transmission lines 212 and corresponding coupling contact elements 214 that enable the communication of data signals between device element 1102 and 1104 when the connector is properly mounted on the device elements 1102 and 1104. In addition, the connector 1106 can include connection sensing contact elements disposed toward the side edges of the connector and in a common plane with coupling contact elements 214 that are between the connection sensing contact elements, as shown in FIG. 3. Alternatively, the connector can be modified so that the connection sensing contact elements are disposed on a different vertical plane than coupling contact elements, similar to the connection sensing contact elements of FIGS. 9 and 10. However, here, instead of employing a localized loop, the connection sensing elements will be coupled to separate transmission lines that run through the length of the connector. These transmission lines will each have a connection sensing contact element at each end of the connector, where one connection sensing contact element of the transmission line is attached to a header in the device element 1102 and another connection sensing contact element is attached to a header in the device element 1104. The header can be configured in a manner that is similar to the header 1014 in FIG. 10, where the contact point for the connection sensing contact elements is on a back end of the header and the contact point for the coupling contact elements connected to functionally coupling lines are disposed on a front end of the header.

As illustrated in FIG. 11, the detection control component of the system 1100 can be implemented by a processor, or factory/test equipment, 1108 in one of the device elements 1102 or 1104. For illustrative purposes, the processor 1108 is implemented in the device element 1102. Here, a closed loop is formed when the connector 1106 is inserted into headers of the device elements 1102 and 1104. The closed loop can be formed by an electric current or an optical signal, each of which is generally referred to herein as a “signal.” In embodiments described herein, a closed loop “signal” need not be a time or space varying quantity but can comprise a simple, constant current or a standing wave for optical signals. However, more complex signals can be applied in accordance with the present principles.

As shown in FIG. 11, when the connector 1106 is inserted in both of the headers of device elements 1102 and 1104, the detection signal 1110 of the closed loop is transmitted through connection sensing contact elements disposed toward the edges of the connector 1106, through transmission lines coupled to the connection sensing contact elements and through both of the coupled devices 1102 and 1104. As such, the loop formed by the detection signal is global in that it includes both of the device elements 1102 and 1104 coupled by the connector 1106. In particular, the detection signal is transmitted through the connection sensing contact elements 1112 and 1114 disposed at one end of the connector 1106 and coupled to the device element 1102 and through the connections sensing contact elements 1116 and 1118 disposed at the other end of the connector 1106 and coupled to the device element 1104. Thus, failure of any one of the connection sensing contact elements 1112, 1114, 1116 and 1118 through which the detection signal is transmitted can be conveyed by monitoring the signal, as discussed in more detail herein below. For example, if the signal is lost, then the processor 1108 can output an indication to the user that at least one of the ends of the connector is not properly seated. Alternatively, as discussed in more detail below, the strength of the signal 1110 can be examined to determine whether one or more of the connection sensing contact elements 1112, 1114, 1116 or 1118 is improperly seated, for example, as discussed above with respect to FIGS. 1 and 2. Use of the global detection loop provides advantages in that the connector need not be modified to include shorter connection sensing contact elements or to include sensing contact elements on a separate plane than coupling contact elements. However, it should be understood that the use of shorter connection sensing contact elements and/or connection sensing elements that are disposed on a different plane can be employed in the system 1100. For example, the shorter connection sensing elements 220 and 222 can be employed so that the existence of the signal 1110 itself indicates that the ends of the connectors are properly seated, as noted above.

With reference to FIG. 12, an embodiment of a system 1200 for detecting an improper seating of a connector that utilizes one or more local detection loops is illustratively depicted. In accordance with this embodiment, the depth sensor status can be determined during assembly through the use of a plurality of factory-automated test equipment. Alternatively, long-term microprocessor monitoring can be employed by looping though the cable to determine the status of the connection sensing contact elements at the ends of the connector.

The system 1200 can include a first device element 1202 and a second device element 1204 that are interconnected by a connector 1206. The device elements 1202 and 1204 can be PCBs, or can be optical devices in embodiments in which optical fibers are employed as transmission lines in the connector 1206. The connector 1206 can be implemented as the connector described above with respect to FIGS. 9 and 10. For example, the connector 1206 can include functional coupling transmission lines 910 that are connected to corresponding coupling contact elements 908, 1012 at each end of the connector 1206 that enable the communication of data signals between device elements 1202 and 1204 when the connector is properly mounted on the device elements 1202 and 1204. In addition, the connector 1206 can include connection sensing contact elements, such as elements 1011, that are disposed toward the side edges of the connector and that form a different plane than a plane formed by coupling contact elements, such as elements 1012, that are between the connection sensing contact elements, as shown in FIGS. 9 and 10. In addition, each of the device elements 1202 and 1204 can include the header 1014 described above with respect to FIG. 10.

As illustrated in FIG. 12, the detection control components of the system 1200 can be implemented by a processor, or factory/test equipment, 1208 in the device element 1202 and by a processor, or factory/test equipment, 1210 in the device element 1204. Here, a local closed loop through which a signal 1212 is transmitted is formed when the connector end 1211 is inserted into a corresponding header in the device element 1202. In addition, another local closed loop through which a signal 1213 is transmitted is formed when the connector end 1215 is inserted into a corresponding header in the device element 1204. The local closed loops can each be formed by a respective electric current or a respective optical signal, each of which is generally referred to herein as a “signal,” as described above with respect to FIG. 11.

Similarly as shown in FIG. 11, when the end 1211 of the connector 1206 is inserted in the header of device element 1202, the detection signal 1212 of the local closed loop is transmitted through connection sensing contact elements 1214 and 1216 disposed toward the edges of the connector 1206, through a corresponding local loopback on the connector at end 1211 coupled to the connection sensing contact elements 1216 and 1214 and through the device element 1202. Similarly, when the end 1215 of the connector 1206 is inserted in the header of device element 1204, the detection signal 1213 of the local closed loop is transmitted through connection sensing contact elements 1218 and 1220 disposed toward the edges of the connector 1206, through a corresponding local loopback on the connector at end 1215 coupled to the connection sensing contact elements 1216 and 1214 and through the device element 1204. As such, the loops formed by the detection signals 1212 and 1213 are local in that they are disposed and implemented independently in the devices 1202 and 1204, respectively. Use of local loops has an advantage in that the particular end of the connector 1206 that is improperly seated can be identified. The signals 1212 and 1213 can be independently examined or monitored to determine whether a properly seated connection has been made or has been lost, respectively, as described in more detail herein below. In addition, as noted above with respect to FIG. 9, connection sensing contact elements 1214, 1216, 1218 and 1220 that are shorter than coupling contact elements in the connector can be employed to ensure that an proper/improper connection can be detected.

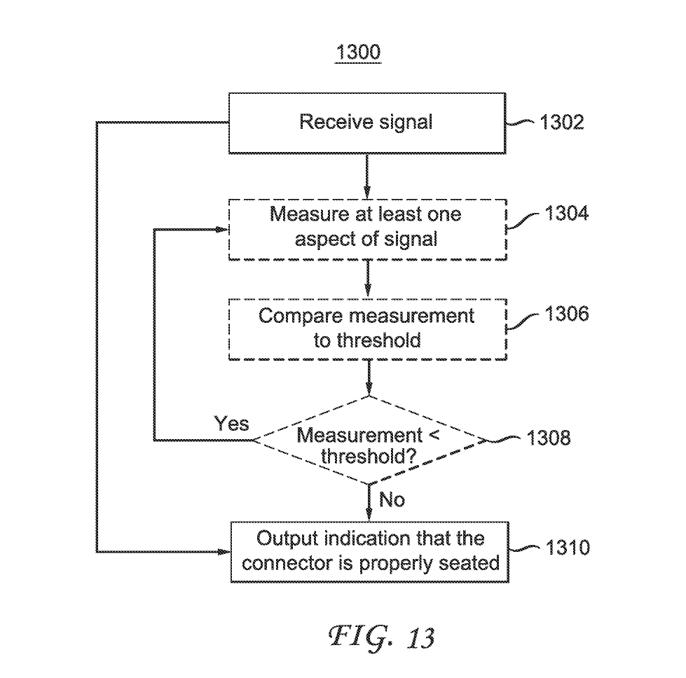

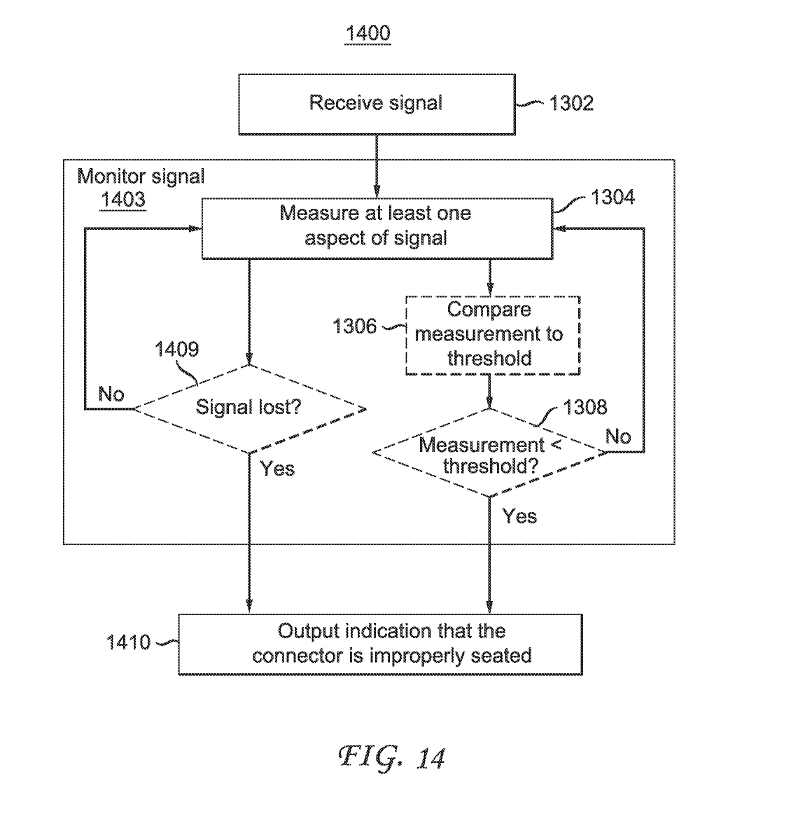

With reference now to FIGS. 13 and 14, methods 1300 and 1400 for determining whether a connector is properly seated in one or more device elements are described. It should be noted that that the methods 1300 and/or 1400 can be implemented in systems 1100 and/or 1200 described above. Reference to a “processor” herein below can correspond to any of the processor elements 1108, 1208 and 1210. In addition, reference to a “detection signal” herein below can correspond to any of the signals 1110, 1212 and 1213 described above. For example, the methods 1300 and/or 1400 can be applied to signal 1110 when the methods are implemented by processor 1108, can be applied to signal 1212 when the methods are implemented by processor 1208 and can be applied to signal 1213 when the methods are implemented by processor 1210.

The method 1300 can be implemented, for example, in a factory setting to determine whether a connector is properly seated or can be implemented in the field should the user replace a connector or repair a connection. The method can begin at step 1302, at which the processor can receive a detection signal. As indicated above, the signal can be a simple current for electrical device embodiments or an optical standing wave for optical device embodiments. The step 1302 can be implemented as soon as a local or global loop is established as a result of a connection of a connector to one or more corresponding device elements, as described above with respect to systems 1100 and 1200. Alternatively, the step 1302 can be implemented after the local or global loop is established, as described above with respect to systems 1100 or 1200, and in response to user-activation of software that performs the method.

In accordance with one exemplary aspect, the method can proceed to step 1310, at which the processor can output to a user an indication that the connector is properly seated. For example, in embodiments in which connection sensing contact elements are shorter than coupling contact elements in the connector, the existence of the detection signal can be an indication that the connector is properly seated. For example, as described above with respect to FIGS. 3-6, due to the length of the connection sensing contact elements, any contact between the connection sensing contact elements with the corresponding sockets in the header(s) can be an indication that the connector is properly seated in the corresponding header(s). As such, upon any receipt of the detection signal at step 1302, the processor can determine that the connector is properly seated and can output a corresponding message indicating the same.

Alternatively, the method can proceed to optional step 1304, at which the processor can measure at least one aspect of the detection signal. For example, in embodiments in which the connector is an electrically conductive connector, the processor can measure the amplitude of the current that implements the detection signal. Alternatively, in embodiments in which the connector is an optical fiber connector, the processor can measure the amplitude of the optical wave that implements the detection signal.

At optional step 1306, the processor can compare the measurement obtained at step 1304 to a threshold. The threshold can be determined by appropriate testing on a given connector and can be input by a user. For example, the user can measure the amplitude of the signal when the connector is properly seated, as, for example, described above with respect to FIG. 4, in one or more of the corresponding device elements to which the connector is attached and can input this measurement as the threshold. Expected signal attenuation or resistance found in the close loop measurement of the design should be calculated and accounted for in the test parameter setup. Each application would include variables, such as connection types, cable length, circuit layout, etc., that depend on the circuit under test that could affect signal loss or resistance. If the measurement obtained at step 1304 is determined, at step 1308, to be below this threshold, then the method can proceed to step 1304 and can be repeated. If the measurement is not below this threshold, then the method can proceed to step 1310, at which the processor can output an indication that the connector is properly seated, as described above.

It should be noted that, in certain cases, the method can be equivalently performed by determining, at step 1308, whether the measurement obtained at step 1304 is above a threshold and outputting the indication that the connector is properly seated at step 1310 if the measurement is above this threshold. For example, the measurement obtained at step 1304 can be the inverse of the amplitude of the signal and the threshold used in the comparison here can be the inverse of the threshold described above. Further, other aspects can be measured and compared to a threshold to determine whether the measurement is above the threshold.

The method 1400 is similar to the method 1300; however, here, the method can be implemented to monitor the status of a connector on an ongoing basis. For example, the method 1400 can begin at step 1302, as described above, at which the processor can receive a detection signal. The method can proceed to step 1403, at which the processor can monitor the detection signal. Step 1403 can be performed on a periodic basis, for example every minute or every hour.

To implement step 1403, the processor can perform step 1304, as described above, and can measure at least one aspect of the signal. In addition, the method can proceed to step 1306, at which the processor can compare the measurement obtained at step 1304 to a threshold, as described above. Further, at step 1308, the processor can determine whether the measurement is less than (or greater than) the threshold as described above. However, if the measurement is not less than (or greater than) the threshold, then the processor can determine that the connector is still properly seated and can proceed to and repeat step 1304. If the measurement is below (or above) the threshold, then the processor can, at step 1410, output to a user an indication that the connector is improperly seated. For example, in embodiments in which the threshold is employed, the processor can indicate that the connection implemented by the connector is at risk of failing and enables the user to repair the connection prior to failing. For example, a falling strength of the detection signal can be an indication that the connector has become improperly seated, due for example, to dropping a device, or is about to disconnect as a result of vibrations over time. As such, the processor can warn a user prior to failure of the connection to ensure that any critical processes are not interrupted or that any critical data is not lost. In addition, in embodiments in which a local detection loop is employed, the indication output at step 1410 can identify the connector and can describe which end of the connector is improperly seated. For example, the indication output at step 1410 can include a representation or a map of the device in which the connector is implemented and can designate the location of the improperly seated end in the representation.

Alternatively, the monitoring of step 1403 can be implemented by monitoring the existence of the signal. For example, in embodiments in which connectors that have contact elements with a consistent length, improper seating of the connector, such as the improper seating described above with respect to FIGS. 1 and 2, can pass initial testing. However, should the connector fail in the field, the processor can notify the user of the improper seating to enable the user to repair the coupling and avoid any loss of functionality, as described above. Accordingly, to implement step 1403, the processor can perform step 1304 by measuring at least one aspect of the detection signal. For example, the processor can determine whether the detection signal exists. Thereafter, the processor can proceed to step 1409, at which the processor can determine whether the signal has been lost. If the signal has not been lost, then the method can proceed to step 1304 and can be repeated. If the processor determines that the signal has been lost, then the method can proceed to step 1410 at which the processor can output an indication that the connector is improperly seated, as described above.

Having described preferred embodiments for systems, apparatuses and methods for detecting improper seating of connectors (which are intended to be illustrative and not limiting), it is noted that modifications and variations can be made by persons skilled in the art in light of the above teachings. It is therefore to be understood that changes can be made in the particular embodiments of the invention disclosed which are within the scope of the invention as outlined by the appended claims. While the forgoing is directed to various embodiments of the present invention, other and further embodiments of the invention can be devised without departing from the basic scope thereof.

1. A connector comprising:
a plurality of transmission lines including functional coupling lines that are configured to transmit data signals; and
a plurality of contact elements at an end of said connector, said contact elements including at least one coupling contact element that is configured to couple at least one of said functional coupling lines to a device element and including at least one connection sensing contact element that is disposed toward at least one side edge of said connector and is shorter than said at least one coupling contact element.

2. The connector of claim 1, said at least one connection sensing contact element is at least one first connection sensing contact element that is disposed toward a first side edge of said at least one side edge, wherein said plurality of contact elements further includes at least one second connection sensing contact element that is disposed toward an opposing, second side edge of said at least one side edge and wherein said at least one coupling contact element is disposed between said at least one first connection sensing contact element and said at least one second connection sensing contact element.

3. The connector of claim 1, wherein said at least one connection sensing contact element is configured to couple at least one other functional coupling line to said device element.

4. The connector of claim 1, wherein said at least one connection sensing contact element includes at least two connection sensing contact elements, wherein said at least one coupling contact element includes at least two coupling contact elements and wherein said at least two connection sensing contact elements form a plane that is different from a plane formed by said at least two coupling contact elements.

5. The connector of claim 1, wherein two of said connection sensing contact elements are directly coupled on said connector to enable local signal transmission between said two of said connection sensing contact elements.

6. The connector of claim 1, wherein said at least one connection sensing contact element is disposed in a stiffener backing of said connector.

7. The connector of claim 1, wherein said at least one connection sensing contact element includes at least one pin.

8. A method for determining whether a connector is properly seated in at least one of a plurality of device elements comprising:
measuring at least one aspect of a signal transmitted through contact elements that are disposed toward opposing side edges of said connector and that are coupled to one of said device elements;
comparing a measurement obtained by said measuring to a threshold value; and
in response to said comparing, outputting an indication that said connector is improperly or properly seated in at least one of said device elements.

9. The method of claim 8, wherein two of said contact elements are directly coupled on said connector such that said signal is transmitted locally between said two of said contact elements.

10. The method of claim 8, wherein said contact elements are a first set of contact elements that is disposed at a first end of said connector, wherein said one of said device elements is a first device element of said plurality of device elements, wherein said signal is also transmitted through a second set of contact elements included in said connector and wherein said second set of contact elements is disposed at a second end of said connector and is coupled to a second device element of said plurality of device elements.

11. The method of claim 8, wherein said contact elements are connection sensing contact elements, wherein said connector further comprises at least one coupling contact element that is configured to couple at least one functionally coupling line in said connector to said one of said device elements for data communication between said one of said device elements and at least one other device element of said plurality of device elements, wherein said at least one coupling contact element is disposed between said connection sensing contact elements and wherein at least one of said connection sensing contact elements is shorter than said at least one coupling contact element.

12. The method of claim 8, wherein said contact elements include at least two connection sensing contact elements, wherein said connector further comprises at least two coupling contact elements that are configured to couple functionally coupling lines in said connector to said one of said device elements for data communication between said one of said device elements and at least one other device element of said plurality of device elements, and wherein said at least two connection sensing contact elements form a plane that is different from a plane formed by said at least two coupling contact elements.

13. The method of claim 8, wherein said contact elements are disposed in a stiffener backing of said connector.

14. The method of claim 8, wherein said contact elements include at least one pin.

15. A method for determining whether a connector is properly seated comprising:
receiving a signal that is transmitted through a plurality contact elements including at least one contact element that is disposed toward a side edge of said connector, wherein a first subset of said plurality of contact elements is disposed at a first end of said connector and is coupled to a first device element and a second subset of said plurality of contact elements is disposed at a second end of said connector and is coupled to a second device element;
monitoring said signal to determine whether said signal has been lost; and
in response to determining that said signal has been lost, outputting an indication that said connector is improperly seated in at least one of said device elements.

16. The method of claim 15, wherein said first subset includes connection sensing contact elements, wherein said connector further comprises at least one coupling contact element that is configured to couple at least one functionally coupling line in said connector to said first device element for data transmissions between said device elements and that is disposed between said connection sensing contact elements and wherein at least one of said connection sensing contact elements is shorter than said at least one coupling contact element.

17. The method of claim 15, wherein said first subset includes at least two connection sensing contact elements, wherein said connector further comprises at least two coupling contact elements that are configured to couple functionally coupling lines in said connector to said first device element for data transmissions between said device elements and that are disposed between said at least two connection sensing contact elements and wherein said at least two connection sensing contact elements form a plane that is different from a plane formed by said at least two coupling contact elements.

18. The method of claim 15, wherein at least one of said first or second subsets includes at least one pin.

19. The method of claim 15, wherein at least one contact element of said first subset is configured to couple at least one functionally coupling line in said connector to said first device element for data transmissions between said device elements.

20. The method of claim 15, wherein at least one of said first or second subsets is disposed in a corresponding stiffener backing of said connector.
